(19) United States
(12) Patent Application Publication
(10) Pub. No.: US 2005/0265295 A1
(43) Pub. Date: Dec. 1, 2005

(54) Server apparatus, client apparatus, and communication control method

(75) Inventor: Yasushi Ishizuka, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/137,366

(22) Filed: May 26, 2005

(30) Foreign Application Priority Data
May 27, 2004 (JP) 2004-157483

(51) Int. Cl. H04Q 7/24; H04J 3/00; H04Q 7/00; H04B 7/212

(52) U.S. Cl. 370/336; 370/442; 370/331

(57) ABSTRACT

An access point determines a wireless communication channel used for stations to transmit and receive data directly to and from each other and informs each of the stations of an instruction to switch to the channel. Thereafter, the access point waits for each of the stations to give notice of the end of the direct data transmission and reception. On the other hand, each of the stations, when receiving the switch instruction, switches to the specified channel and executes direct data transmission and reception. After finishing the direct data transmission and reception, each of the stations switches to the original channel and informs the access point of the end of the direct data transmission and reception. As a result of this, the access point and the stations restart wireless communication with one another.

### CROSS-REFERENCE TO RELATED APPLICATIONS

This application is based upon and claims the benefit of priority from prior Japanese Patent Application No. 2004-157483, filed May 27, 2004, the entire contents of which are incorporated herein by reference.

### BACKGROUND OF THE INVENTION

1. Field of the Invention

The present invention relates to communication control technology, for example, a wireless LAN, for enabling client apparatuses connected to a server apparatus to transmit and receive data directly to and from each other.

2. Description of the Related Art

In recent years, home servers to which electronic home appliances, including television sets and recorder units, can be connected have been popularized. Since home servers function as access points, the data transmission and reception between client apparatuses, including television sets and recorder units, are basically carried out via home servers.

Recently, various methods which enable client apparatuses to transmit and receive data directly to and from each other without the intervention of server apparatuses have been proposed (refer to, for example, Jpn. Pat. Appln. KOKAI Publication No. 11-252114). In the wireless packet transfer method disclosed in Jpn. Pat. Appln. KOKAI Publication No. 11-252114, packets are transferred only to wireless terminals with a strong possibility that packet transfer will succeed by a direct transfer method. To the other wireless terminals, packets are transferred by a relay transfer method via wireless base stations, thereby enabling efficient data transmission and reception.

In the wireless packet transfer method disclosed in Jpn. Pat. Appln. KOKAI Publication No. 11-252114, each of the wireless terminals has the function of determining the probability that the present terminal will transfer packets successfully to a wireless terminal acting as a receiver of the packets by a direct transfer method based on the state where the present terminal receives the transmission packets, transferred by the wireless terminal acting as the receiver of the packets, addressed to an arbitrary wireless terminal. The wireless terminals determined to have a high success probability are registered in a table, enabling packets to be transferred by a direct transfer method only to the wireless terminals with a high probability that packet transfer will succeed by a direct transfer method, which enables effective data transmission and reception.

Since a home server system is a communication system intended to be installed in the home, it is strongly required to be provided at lower cost. In addition, since the wireless communication range is restricted, mounting a large-scale function as described above on each client apparatus is unrealistic from a cost-benefit viewpoint. Moreover, in a home server system where a plurality of communication devices communicate with one another wirelessly in a limited range, how to use radio frequency bands more efficiently is a more important problem.

### BRIEF SUMMARY OF THE INVENTION

According to an embodiment of the present invention, a server apparatus comprises a wireless communication unit configured to perform a wireless communication with a plurality of client apparatuses; a determining unit configured to determine a wireless communication channel used for a first and a second client apparatus of the plurality of client apparatuses to transmit and receive data directly to and from each other; a informing unit configured to inform the first and second client apparatuses of an instruction to switch to the channel determined by the determining unit; and a communication control unit configured to wait for the first and second client apparatuses to give notification of the end of the direct data transmission and reception after the channel switch instruction is informed by the informing unit, and to restart wireless communication with the first and second client apparatuses when receiving the notification.

According to another embodiment of the present invention, a client apparatus comprises a wireless communication unit configured to perform a wireless communication with a server apparatus; a data transmitting and receiving unit configured to transmit and receive data directly to and from one other client apparatus performing wireless communication with the server apparatus; a receiving unit configured to receive an instruction to switch to a channel used to transmit and receive data directly to and from the one other client apparatus from the server apparatus; and a communication control unit configured to switch to a channel and execute the direct data transmission and reception to and from the one other client apparatus when the receiving unit has received a channel switch instruction, and to switch back to the original channel, inform the server apparatus of the end of the direct data transmission and reception and restart wireless communication with the server apparatus when the data transmission and reception is completed.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 shows a network configuration of a communication system according to an embodiment of the present invention;

FIG. 2 is a block diagram schematically showing the configuration of an access point in the embodiment;

FIG. 3 shows an example of communication management data stored in the data storage section included in the access point of the embodiment;

FIG. 4 is a block diagram schematically showing the configuration of a station in the embodiment;

FIG. 5 is a diagram to help explain two routes which can be taken in transmitting and receiving data between stations in the communication system of the embodiment;

FIG. 6 is a diagram to help explain the direct data transmission and reception start procedure executed by the access point and station in the embodiment;

FIG. 7 is a flowchart to help explain the control sequence related to the direct data transmission and reception at the access point of the embodiment;

FIG. 8 is a flowchart to help explain the control sequence related to the direct data transmission and reception at the station of the embodiment;

FIG. 9 is a first diagram to help explain an example of communication control realized in the communication system of the embodiment;

FIG. 10 is a second diagram to help explain an example of communication control realized in the communication system of the embodiment;

FIG. 11 is a third diagram to help explain an example of communication control realized in the communication system of the embodiment; and

FIG. 12 is a diagram to help explain a modification where each station is caused to monitor the status of use of each channel.

### DETAILED DESCRIPTION OF THE INVENTION

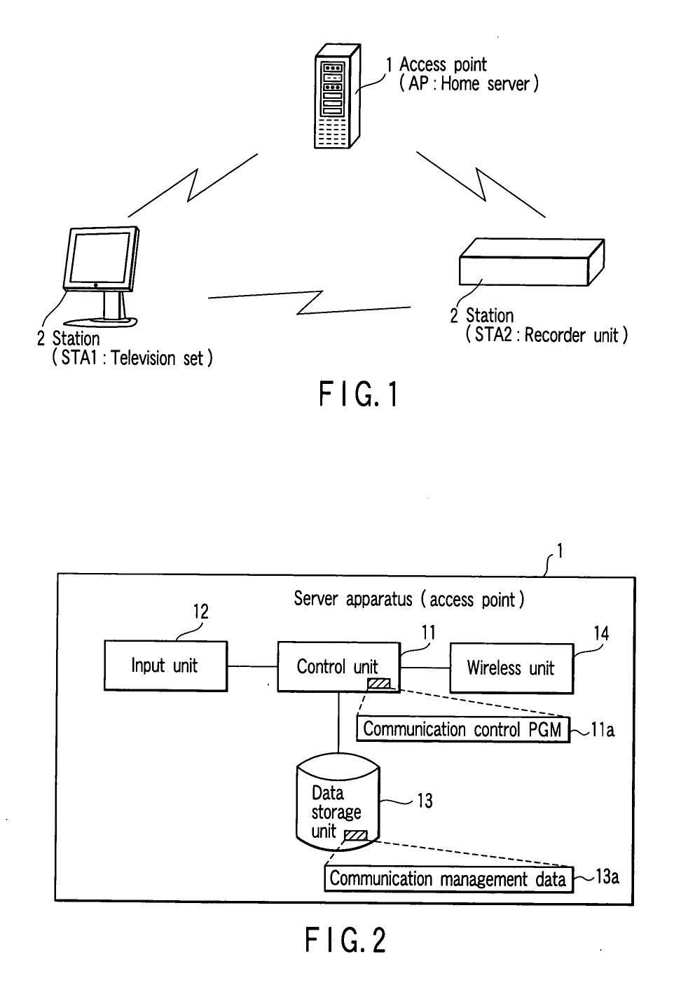

Hereinafter, referring to the accompanying drawings, an embodiment of the present invention will be explained. FIG. 1 shows a network configuration of a communication system according to the embodiment.

In the communication system, an access point 1 as a server apparatus and stations 2 as client apparatuses communicate with one another wirelessly according to the IEEE 802.11 standard, thereby establishing a LAN. It is assumed that a home server is installed as the access point 1 and a television set and a recorder unit are installed as the stations 2. Not only the television set and recorder unit but also various types of electronic devices (not shown) may be used as the station 2.

In IEEE 802.11e, a version of the IEEE 802.11 standard, the transmission and reception of sound and moving images have been taken into account. A rule for stations 2 to transmit and receive data directly to and from each other is now being developed as Direct Link Protocol (DLP). Use of DLP enables a television set and a recorder unit to transmit and receive data without the intervention of a home server. Here, suppose access point 1 and each of the stations 2 perform wireless communication according to the IEEE 802.11e standard.

When the stations 2 performing wireless communication with access point 1 transmit and receive data directly to and from each other, access point 1 generally shares a channel for wireless communication with the other stations 2 in a time-division manner. In this case, it is hard to say that the radio frequency bands are being used efficiently. For example, the data transmission and reception related to data processing required to have good real-time response can be adversely affected. Hereinafter, to use the radio frequency bands efficiently when the stations 2 transmit and receive data directly to and from each other, how access point 1 and each of the stations 2 in the communication system perform control will be explained.

FIG. 2 is a block diagram schematically showing the configuration of access point 1, which is a server apparatus. As shown in FIG. 2, access point 1 includes a control unit 11, an input unit 12, a data storage unit 13, and a wireless unit 14.

The control unit 11, which supervises the whole of access point 1, has various programs for various controls. One of the programs is a communication control program 11a to perform control when the stations 2 transmit and receive data directly to and from each other. The input unit 12, which is an interface mechanism that receives an operation specified by the user, transmits the contents of the received instruction to the control unit 11. The data storage unit 13, which is a storage medium, such as a hard disk drive (HDD), stores various types of data, including communication management data 13a used by a communication control program 11a. The wireless unit 14 controls wireless communication with the stations 2.

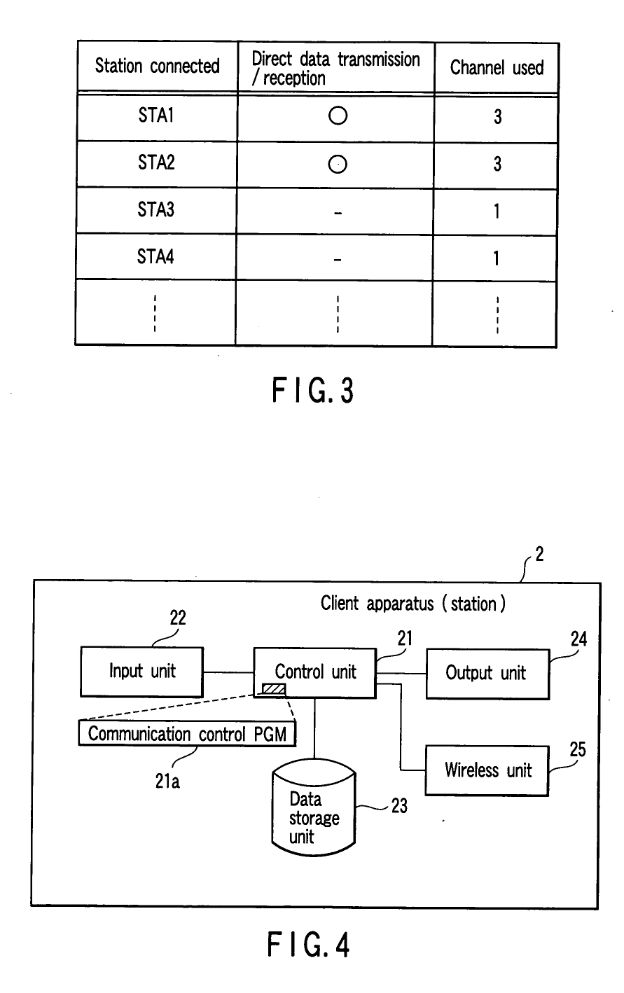

FIG. 3 shows an example of the communication management data 13a stored in the data storage unit 13. Using the communication control data 13a, the communication control program 11a of the control unit 11 manages the stations 2 being connected, the stations 2 transmitting and receiving data directly to and from each other, and the channels being used by the stations 2. In the example of FIG. 3, at least four stations 2 whose identification IDs are STA1 to STA4 are connected to access point 1. Of them, the station 2 whose identification ID is STA1 and the station whose identification ID is STA2 are transmitting and receiving data directly and channel 3 and channel 1 are busy. Of the busy channels shown in the communication management data 13a, the one used by the station 2 which does not perform direct transmission and reception is the channel the access point 1 uses in communicating with each of the stations 2 wirelessly (in this chase, channel 1).

FIG. 4 is a block diagram schematically showing the configuration of the station 2 acting as a client apparatus. As shown in FIG. 4, the station 2 includes a control unit 21, an input unit 22, a data storage unit 23, an output unit 24, and a wireless unit 25. Of these, the control unit 21, input unit 22, data storage unit 23, and wireless unit 25 function almost the same as the control unit 11, input unit 12, data storage unit 13, and wireless unit 14, respectively. A communication control program 21a of the control unit 21 controls direct data transmission and reception to and from the other station 2 according to an instruction from the communication control program 11a of access point 1. The output unit 24 is an interface mechanism for showing the user, for example, the result of the data processing performed by the control unit 21.

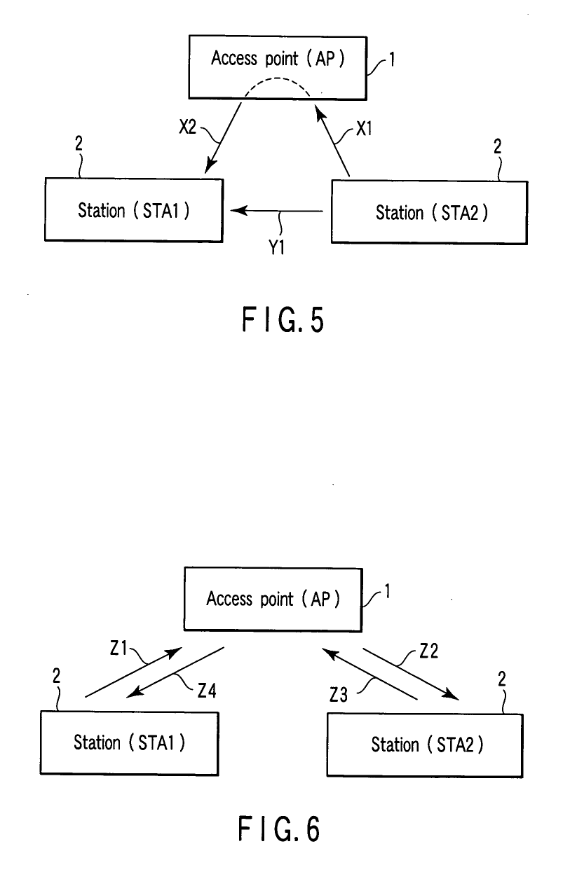

As described above, in the communication system, access point 1 and the stations 2 perform wireless communication according to the IEEE 802.11e standard. Specifically, when data is transferred from one station 2 to another station 2 as shown in FIG. 5, for example, when a recorder unit (STA2) transmits recording data to a television set (STA1), not only a general route (X1+X2) passing through access point 1 but also a route (Y1) not passing through access point 1 can be selected. If the latter route is selected, access point 1 and the relevant one of the stations 2 execute the procedure for starting direct data transmission and reception according to the sequence shown in FIG. 6.

First, the television set (STA1) informs the home server (AP) of a request for direct data transmission and reception to and from the recorder unit (STA2) (Z1 of FIG. 6). Then, the home server informs the recorder unit of an instruction to perform direct data transmission and reception to and from the television set (Z2 of FIG. 6). In response to this instruction, the recorder unit returns a direct data transmission and reception permit status to the home server (Z3 of FIG. 6). Then, the direct data transmission and reception permit status from the recorder unit is transferred from the home server to the television set (Z4 of FIG. 6). This completes the procedure for starting direct data transmission and reception, which enables direct data transmission and reception between the stations 2. While the television set has requested the home server to perform direct data transmission and reception to and from the recorder unit, the home server may request the television set and recorder unit to perform direct data transmission and reception between them.

After the procedure for starting direct data transmission and reception is completed, direct data transmission and reception between the stations 2 can be performed. In the communication system, however, to use the radio frequency bands efficiently, access point 1 and each of the stations 2 further perform control as described below.

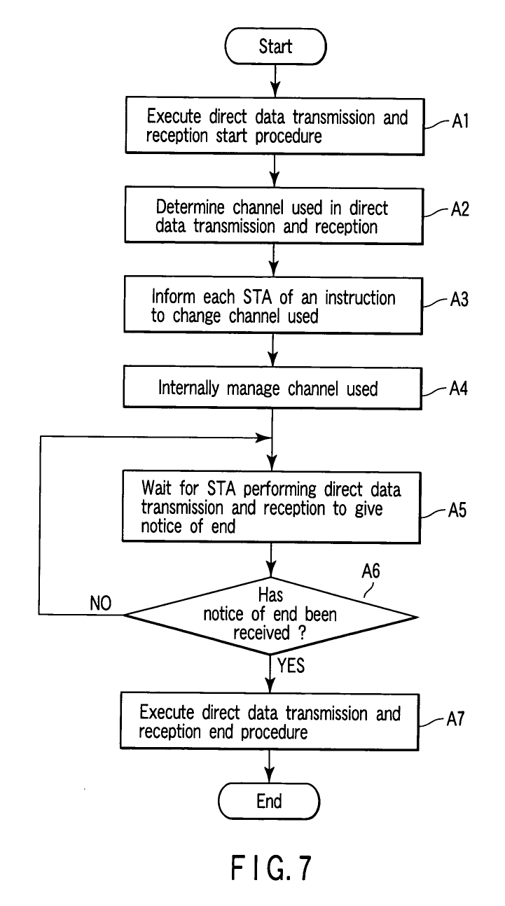

FIG. 7 is a flowchart to help explain the control procedure for direct data transmission and reception at access point 1. The control procedure of FIG. 7 is defined by the description of the communication control program 11a and realized by the control unit 11.

After the procedure for starting direct data transmission and reception is completed (step A1), the control unit 11 determines a channel each of the stations 2 executing direct data transmission and reception is to use in the direct data transmission and reception (step A2). To determine the channel, the control unit 11 refers to the communication management data 13a, finds channels other than the one being used, that is, unused channels, and selects any one of the unused channels. As a result, when direct data transmission and reception is first performed, any one of the channels excluding the one used by access point 1 for wireless communication with each of the stations 2 is selected. When another direct data transmission and reception is performed during the direct data transmission and reception, any one of the channels excluding these two channels is selected. From this point on, a channel for new direct data transmission and reception is selected one after another by the same procedure. When selecting a channel, the control unit 11 preferentially uses a channel whose frequency is farther away from that of the channel being used to prevent the channels from interfering with each other.

After determining the channel, the control unit 11 informs each of the stations 2 executing direct data transmission and reception that the present channel is changed to the determined one (step A3). Then, the control unit 11 records in the communication management data 13a that the channel has become busy (step A4). On being informed, the station 2 changes the channel and escapes from the control of access point 1 and proceeds to direct data transmission and reception. The control unit 11 waits for the stations 2 to give notice of the end of direct data transmission and reception from (step A5). On receiving the notice (YES in step A6), the control unit 11 carries out the procedure for ending the direct data transmission and reception including the update of the communication management data 13a (step A7) and restarts wireless communication with each of the stations 2.

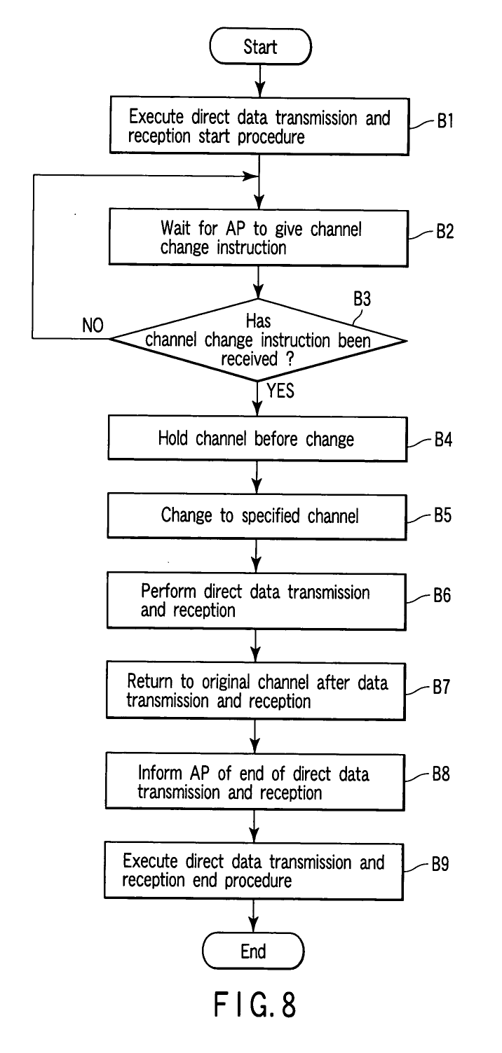

FIG. 8 is a flowchart to help explain the control procedure for direct data transmission and reception at the station 2. The control procedure of FIG. 8 is defined by the description of the communication control program 21a and realized by the control unit 21.

After the procedure for starting direct data transmission and reception (step B1) has been completed, the control unit 21 waits to be informed by access point 1 of a channel change instruction (step B2). On being informed of the instruction (YES in step B3), the control unit 21 stores the present channel in, for example the data storage unit 23 (step B4) and then changes the channel to the specified channel (step B5).

After changing the channel, the control unit 11 starts direct data transmission and reception to and from another station 2 (step B6). Thereafter, on having completed the direct data transmission and reception, the control unit 11 changes the channel to the stored channel (step B7) and informs access point 1 of the end of the direct data transmission and reception (step B8). Then, the control unit 11 carries out the procedure for ending the direct data transmission and reception to return the state of the station to wireless communication with access point 1 (step B9) and restarts wireless communication with access point 1.

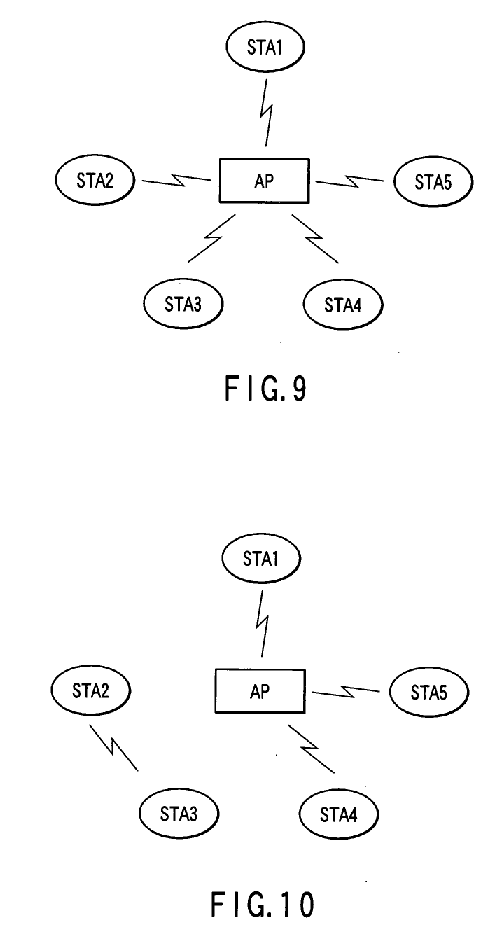

As described above, access point 1 and each of the stations 2 perform control of direct data transmission and reception in a coordinated manner, which realize communication control as shown in, for example, FIGS. 9 to 11.

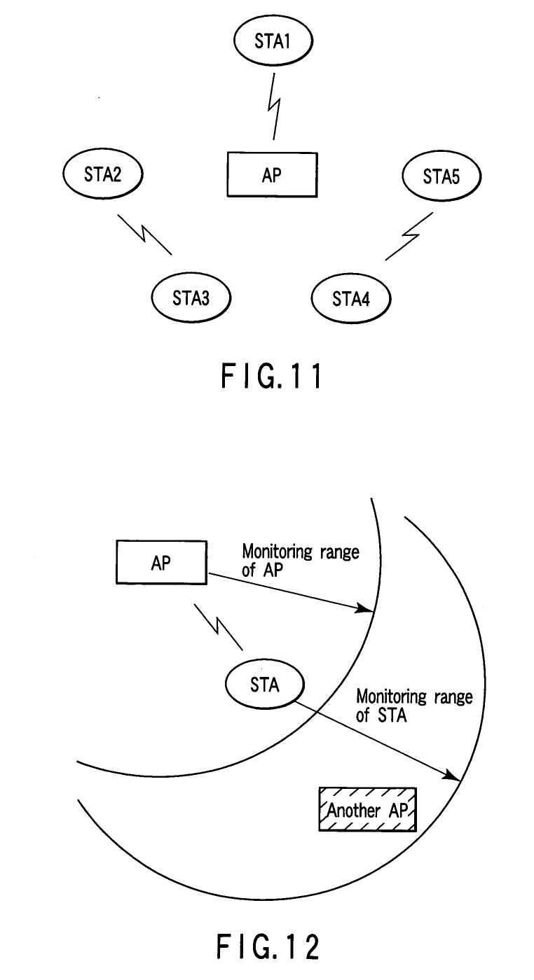

Suppose five stations 2 are connected to access point 1 as shown in FIG. 9. If two of the five stations 2 go into direct data transmission and reception as shown in FIG. 10, these will use a channel different from the one between access point 1 and the stations 2. If two of the remaining three stations 2 further go into direct data transmission and reception during the direct data transmission and reception as shown in FIG. 11, these will use a channel different from the one between access point 1 and the stations 2 and the one used in the direct data transmission and reception now being performed. This enables the radio frequency bands to be used efficiently.

In the embodiment, when informing each of the stations 2 performing direct data transmission and reception of a channel change instruction, the control unit 11 of access point 1 has referred to the communication management data 13a, found the unused channels, and selected the channel whose frequency is farthest away from that of the channel being used. Alternatively, the status of use of each channel may be monitored, for example, periodically or at regular intervals and the channel whose frequency of use is the lowest may be selected from the unused channels.

Furthermore, if each of the stations 2 is caused to monitor the status of use of each channel, for example, periodically or at regular intervals, and access point 1 acquires information about the status of use of each channel, this makes it possible to recognize the status of each of the channels more extensively than when only access point 1 monitors the status, which enables more suitable channel selection as shown in FIG. 12.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A server apparatus comprising:
a wireless communication unit configured to perform a wireless communication with a plurality of client apparatuses;
a determining unit configured to determine a wireless communication channel used for a first and a second client apparatus of the plurality of client apparatuses to transmit and receive data directly to and from each other;
a informing unit configured to inform the first and second client apparatuses of an instruction to switch to the channel determined by the determining unit; and
a communication control unit configured to wait for the first and second client apparatuses to give notification of the end of the direct data transmission and reception after the channel switch instruction is informed by the informing unit, and to restart wireless communication with the first and second client apparatuses when receiving the notification.

2. The server apparatus according to claim 1, wherein the determining unit determines any one of the channels excluding the one being used in performing wireless communication with the plurality of client apparatuses to be a channel used for the first and second client apparatuses to transmit and receive data directly to and from each other.

3. The server apparatus according to claim 2, wherein the determining unit determines the channel whose frequency is farthest away from that of the channel being used among the usable channels excluding the one being used to be the channel for direct data transmission and reception.

4. The server apparatus according to claim 3, wherein the determining unit acquires information indicating the status of use of each channel from each of the plurality of client apparatuses, and determines the channel whose frequency of use is the lowest based on the acquired information to be the channel for direct data transmission and reception when more than one channel whose frequency is farthest away from the channel being used exits.

5. The server apparatus according to claim 2, wherein the determing unit acquires information indicating the status of use of each channel from each of the plurality of client apparatuses, and determines the channel whose frequency of use is the lowest based on the acquired information to be the channel for direct data transmission and reception among the usable channels excluding the one being used.

6. The server apparatus according to claim 5, wherein the determing unit determines the channel whose frequency is farthest away from the channel being used to be the channel for direct data transmission and reception when more than one channel whose frequency of use is the lowest exits.

7. The server apparatus according to claim 2, wherein the determining unit determines any one of the channels excluding the one being used for wireless communication with the plurality of client apparatuses and the one being used for the first and second client apparatuses to execute direct data transmission and reception to be a channel used for a third and a fourth client apparatuses of the plurality of client apparatuses to transmit and receive data directly to and from each other, when the first and second client apparatuses are executing the direct data transmission and reception and the third and fourth client apparatus transmit and receive data directly to and from each other.

8. A client apparatus comprising:
a wireless communication unit configured to perform a wireless communication with a server apparatus;
a data transmitting and receiving unit configured to transmit and receive data directly to and from one other client apparatus performing wireless communication with the server apparatus;
a receiving unit configured to receive an instruction to switch to a channel used to transmit and receive data directly to and from the one other client apparatus from the server apparatus; and
a communication control unit configured to switch to a channel and execute the direct data transmission and reception to and from the one other client apparatus when the receiving unit has received a channel switch instruction, and to switch back to the original channel, inform the server apparatus of the end of the direct data transmission and reception and restart wireless communication with the server apparatus when the data transmission and reception is completed.

9. The client apparatus according to claim 8, further comprising:
a monitoring unit configured to monitor the status of use of each of the channels; and
a transmitting unit configured to transmit information indicating the status of use of each of the channels acquired by the monitoring unit to the server apparatus.

10. A communication control method in a communication system where a plurality of client apparatuses perform wireless communication with a server apparatus, the method comprising:
performing, by the server apparatus, processings of
determining a wireless communication channel used for two of the plurality of client apparatuses to transmit and receive data directly to and from each other, informing the two client apparatuses of an instruction to switch to the channel, and waiting for the two client apparatuses to give notice of the end of the direct data transmission and reception;
performing, by each of the plurality of client apparatuses, processings of
receiving an instruction to switch to a channel used to execute the direct data transmission and reception to and from one other client apparatus from the server apparatus, switching to the channel, executing the direct data transmission and reception to and from the one other client apparatus, switching back to the original channel when the direct data transmission and reception is completed, and informing the server apparatus of the end of the direct data transmission and reception; and
performing, by each of the server apparatus and the plurality of client apparatuses, processing of
restarting wireless communication between one another when being informed of the end of the direct data transmission and reception.
